(19) United States
(12) Patent Application Publication
(10) Pub. No.: US 2024/0363930 A1
(43) Pub. Date: Oct. 31, 2024

(54) CONTROLLED CURING OF SILICONE POLYMERS IN A BATTERY APPLICATION

(71) Applicant: Canoo Technologies Inc., Torrance, CA (US)

(72) Inventor: Amit Ranjan, Royal Oak, MI (US)

(21) Appl. No.: 18/309,442

(22) Filed: Apr. 28, 2023

(51) Int. Cl. H01M 10/659; H01M 10/613; H01M 10/625; H01M 10/6551

(52) U.S. Cl. CPC H01M 10/659; H01M 10/613; H01M 10/625; H01M 10/6551; H01M 2220/20

(57) ABSTRACT

In using silicone to control thermal runaway in a battery module for an electric vehicle, a mold is provided to hold a plurality of energy storage elements with spaces in between adjacent ones thereof. Substantially uncured silicone polymer mixture is injected into the mold to fill the spaces. During fill of the mold with the injected silicone polymer mixture, variation is introduced of one or more of: a ratio of constituents of the silicone polymer mixture being injected; at least one of a presence or absence of additive(s) in the injected silicone polymer mixture, type(s) of the additive(s) in the injected silicone polymer mixture, or concentrations of the additive(s) in the injected silicone polymer mixture; or mold temperature. Upon completion of the fill of the mold with the injected silicone polymer mixture, curing of the injected silicone polymer mixture is completed. Precise, fast cure of the silicone is achieved.

### TECHNICAL FIELD

This disclosure relates generally to electric vehicles. More specifically, this disclosure relates to thermal potting for batteries within electric vehicles.

### BACKGROUND

Electric vehicles (EVs) utilize batteries that typically consist of several smaller cells arranged together. The more cells that can be packed into the available space, the higher the energy density, which determines the range or power of the vehicle. A major limitation in growing the energy density of batteries is the ability to contain a fire or a thermal runaway originating from a cell. In such an event, high temperature gases, particles or flames are expelled from the cells, which when exposed to other cells in the battery can lead to a chain reaction of more cells going into such thermal runaway. A battery design must contain such a reaction. Additional background regarding thermal runaway may be found in U.S. patent application Ser. No. 17/814,204 filed Jul. 21, 2022 and entitled MITIGATING THERMAL RUNAWAY OF LITHIUM-ION BATTERIES, which is incorporated herein.

Expanding polyurethane (PU)-based foams or expanding epoxies—the “traditional solutions”—have been used as thermal runaway mitigation solutions which fill up the physical space in between or over the battery cells, and limit a chain reaction by some combination of consumption, containment, or redistribution of the heat of the thermal event. Although the expanding nature of these solutions helps with their application during the manufacturing process, the additives which make the expansion possible may not directly be participating or at times be detrimental to the runaway mitigation objectives, hence limiting the effectiveness of such solutions. Further, the expanding mechanism of their application requires physical enclosure of the batteries during the process in order for them not to escape into unintended areas.

An alternative to the traditional solutions are silicone based polymers, which have liquid like fluidity during application and cure into solid around the cells, providing similar or better protections compared to traditional solutions while taking advantage of the absence of a need for expansion. Silicone application typically consists of a mix of two or more liquid/gel/solid constituents, whose curing reactions are triggered when the participating reactants come into contact with each other under the right temperature and pressure conditions. Because the mix is fluid, silicone polymer is more forgiving than traditional solutions in terms of the need for sealed enclosures. For the manufacturing process, the constituents are mixed together, injected into the battery within a temporary enclosure (“mold”) and left to cure until enough solidification has been achieved, before ejecting the battery out of the mold.

### SUMMARY

This disclosure relates to use of silicone to control thermal runaway in batteries for an electric vehicle.

In certain embodiments, a method includes providing a mold holding a plurality of energy storage elements with spaces in between adjacent ones thereof. The method includes beginning injection of uncured silicone mixture into the mold to fill the spaces. During fill of the mold with the injected silicone mixture, variation is introduced of one or more of: a ratio of constituents of the silicone mixture being injected; at least one of a presence or absence of additive(s) in the injected silicone mixture, type(s) of the additive(s) in the injected silicone mixture, or concentrations of the additive(s) in the injected silicone mixture; or temperature in one of the mold as a whole or specific portions of the mold. Upon completion of the fill of the mold with the injected silicone mixture, and upon enough time under the right physical conditions of the mold, the temperature of the one of the mold as a whole or the specific portions of the mold is controlled until curing of the injected silicone mixture is complete. (“Completion of curing” in context of this disclosure refers to a state of the polymers where enough solidification or hardening has been achieved to endure physical movement of the battery without degradation. This may or may not be the completion of polymerization reactions of the polymer.)

In some embodiments, curing of the injected silicone mixture may comprise controlling other physical conditions of the mold in addition to temperature.

In some embodiments, the method may further include, after completing curing of the injected silicone foam mixture, removing the plurality of energy storage elements and cured silicone from the mold.

In some embodiments, the plurality of energy storage elements may correspond to a battery for an electric vehicle.

In some embodiments, the battery may be configured to be held within a skateboard platform.

In some embodiments, the method may comprise varying the ratio of the constituents in the silicone mixture between one ratio at a start of the fill of the mold and a different ratio during the fill or at an end of the fill of the mold.

In some embodiments, the different ratios of the constituents may have different cure rates.

In some embodiments, the silicone mixture with the different ratios of the constituents may have different viscosities.

In some embodiments, the method may comprise including no additive in the silicone mixture at a start of the fill of the mold and including an additive in the silicone mixture during the fill of the mold.

In some embodiments, the method may comprise including a first amount of an additive in the silicone mixture at a start of the fill of the mold and a second amount of the additive in the silicone mixture during the fill of the mold.

In some embodiments, the method may comprise including a first type of additive in the silicone mixture at a start of the fill of the mold and a second type of additive in the silicone mixture during the fill of the mold.

In some embodiments, the first type of additive may be a curing inhibitor and the second type of additive may be a curing accelerator.

In some embodiments, the fill of the mold may comprise injection of the silicon mixture from multiple pathways into the mold.

In some embodiments, the fill of the mold may comprise fill of the mold from a bottom of the mold up. (“Bottom of the mold up” refers to the flow of the silicone mixture against the direction of flow if the mixture were to flow only under the influence of gravitational forces. Bottom up fill allows air previously occupying the empty spaces or any gaseous bi-products of the curing reactions to be naturally pushed out by the silicone mixture filling up the space, hence providing a uniform and void free silicone polymer upon completion of curing.)

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example electric vehicle receiving some or all of the necessary propulsion energy from a battery manufactured according to embodiments of the present disclosure;

FIG. 2 illustrates an example vehicle framework and an example battery enclosure in accordance with embodiments of this disclosure;

FIGS. 3A and 3B illustrate exemplary batteries of an electric vehicle manufactured according to embodiments of the present disclosure;

FIG. 4 illustrates an example battery manufacturing method according to embodiments of the present disclosure; and

FIG. 5 is a high level flowchart for a process of silicone application to inter-energy storage element gaps during battery manufacture according to embodiments of the present disclosure.

### DETAILED DESCRIPTION

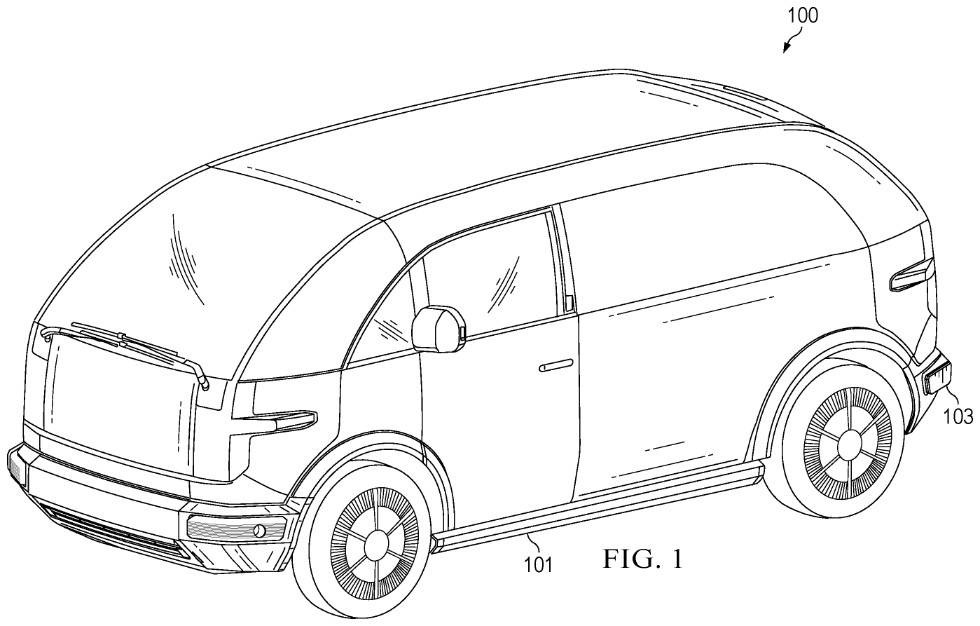

FIGS. 1 through 5, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

One consideration in using a silicone based polymer to encase battery cells as described above is that the rate of curing reaction determines the length of time between mixing and ejection. It is desirable to have as much time as possible between mixing constituents and injecting the mixture into a mold, but as little time as possible between injection and ejection from the mold. Constituent ratios may be tweaked or additives introduced to the mixture to accelerate or decelerate the curing reaction, but such changes to the mixture merely achieve a single rate of reaction. The reaction rate cannot be controlled by the manufacturer depending on the step of the application process, which limits the ability of the battery manufacturer to maintain a high production volume rate and therefore significantly increases the need for capital investment, factory floor space, and operational costs due to waste of silicone polymer from unintentional curing.

The present disclosure provides control over the rate of a silicone curing reaction through precise control of one or more of three factors: a) control of the temperatures of the mixture at various stages of the process, or use of heat in general; b) controlled alteration of the ratio of the constituents; and c) controlled injection of additives (e.g., reaction inhibitors or accelerators).

FIG. 1 illustrates an example electric vehicle receiving some or all of the necessary propulsion energy from a battery manufactured according to embodiments of the present disclosure. The embodiment of the electric vehicle 100 illustrated in FIG. 1 is for illustration and explanation only. FIG. 1 does not limit the scope of this disclosure to any particular implementation of electric vehicle. For example, the process described herein can apply to batteries in a fully battery-powered electric vehicle, or to batteries within a hybrid vehicle where part of the propulsion energy comes from an internal combustion engine and part from a battery. Notably, the battery manufacturing process may also be used to manufacture energy storage for other battery-powered devices or systems.

In the example illustrated in FIG. 1, the electric vehicle 100 may include a top hat structure coupled to an electric vehicle platform, where the platform of vehicle 100 includes a chassis (not visible in FIG. 1) supporting a body 101 for carrying the operator, passengers and/or cargo. In some embodiments, the chassis of the vehicle 100 is in the form of a “skateboard” vehicle platform supporting the one or more energy storage elements (batteries) that provide input electrical power used by various components, such as one or more electric motors of the electric vehicle 100 and a control system of the electric vehicle 100. The top hat structure is designed and dimensioned to have at least a cabin configured to provide space for one or more persons to sit and either operate or ride in the electric vehicle.

The operator and/or passengers may enter and exit the cabin through at least one door forming part of the cabin. A separate structure may permit access to the storage, such as one or more sliding side door(s), a rear lift gate, a rear tailgate, or some combination of the same. A transparent windshield and other transparent panels mounted within and forming part of the cabin allow at least one passenger (referred to as the “operator”) to see outside the cabin. Rear-view mirrors mounted to sides of the cabin enable the operator to see objects to the sides and rear of the cabin and may include warning indicators (such as selectively illuminated warning lights) for features such as blind spot warning (indicating that another vehicle is in the operator's blind spot) and/or lane departure warning.

Although FIG. 1 illustrates one example of an electric vehicle 100, those skilled in the art will recognize that the full structure and operation of a suitable vehicle are not depicted in the drawings or described here. Instead, for simplicity and clarity, only so much of the structure and operation as is necessary for an understanding this disclosure is depicted and described. Various changes may be made to the example of FIG. 1, and improved battery module manufacturing to mitigate thermal runaway as described in this disclosure may be used with any other suitable vehicle or any other suitable battery-powered device or system

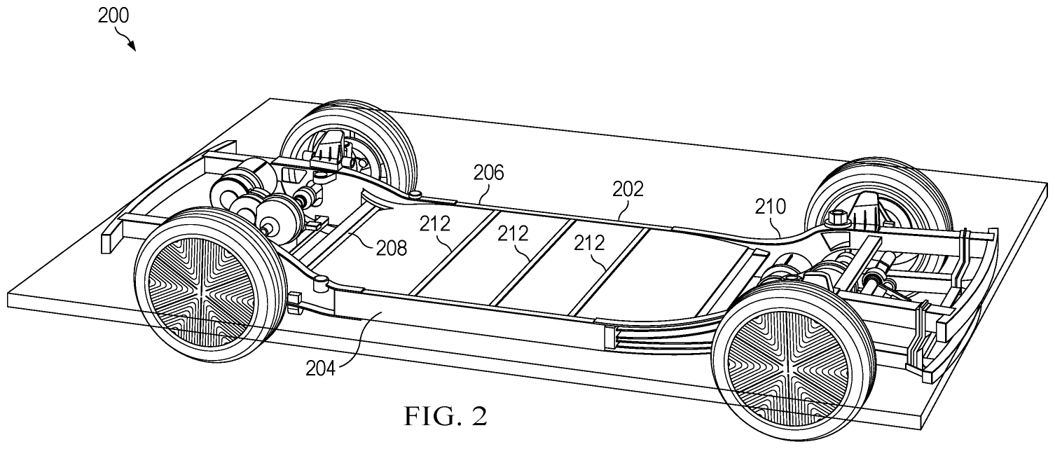

FIG. 2 illustrates an example vehicle framework 200 and an example battery enclosure 202 in accordance with embodiments of this disclosure. The embodiment of the vehicle framework 200 illustrated in FIG. 2 is for illustration and explanation only. FIG. 2 does not limit the scope of this disclosure to any particular implementation of vehicle framework.

In some embodiments, the vehicle framework 200 can incorporate the battery enclosure 202 within an open mid-section of the vehicle framework 200. For example. FIG. 2 illustrates an embodiment of the vehicle framework 200 with a forward end and a rear end. A center section represents what may be considered the battery compartment of the vehicle framework 200. The vehicle framework 200 can include various components, such as side rails 204 and 206 and forward and rear cross members 208 and 210, to make up the exterior walls or framework of the battery compartment. The framework 200 can also include additional components that subdivide the interior space of the mid-body or battery enclosure 202 into a number of separated interior spaces. For instance, the battery compartment may contain additional cross members 212 that transverse the width of the framework. Such cross members can act to add additional strength (twisting, bending, and impact) to the framework of the vehicle 100 and provide additional structural support for the battery modules. The cross members 212 may also serve to provide structural support and connection points for additional elements within the body of the vehicle, such as seating elements and/or upper body components.

Although FIG. 2 illustrates one example of a vehicle framework 200, those skilled in the art will recognize that the full structure of a suitable vehicle framework (e.g., skateboard platform) are not depicted in the drawings or described here. Instead, for simplicity and clarity, only so much of the structure as is necessary for an understanding this disclosure is depicted and described. Various changes may be made to the example of FIG. 2, and improved battery module manufacturing to mitigate thermal runaway as described in this disclosure may be used with any other suitable vehicle framework.

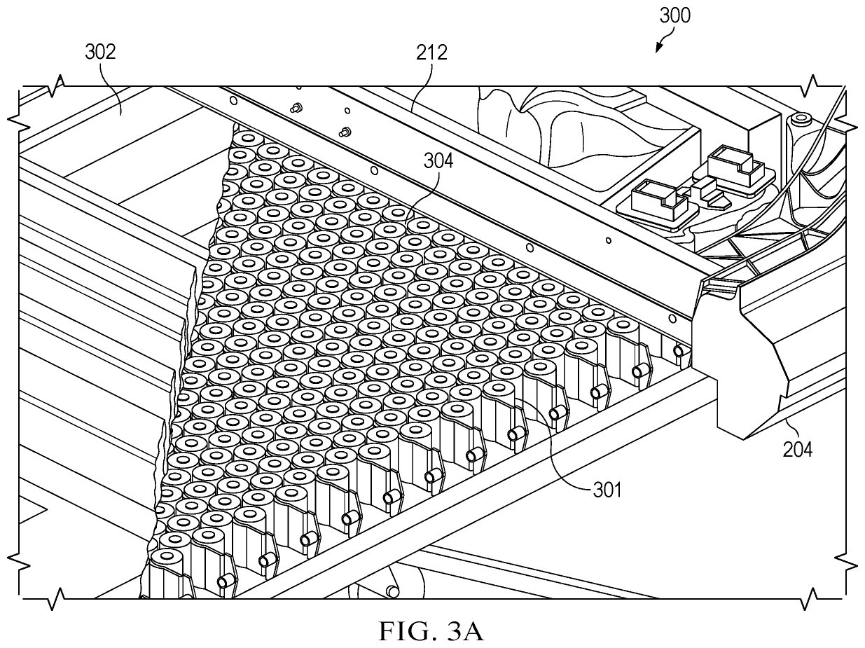

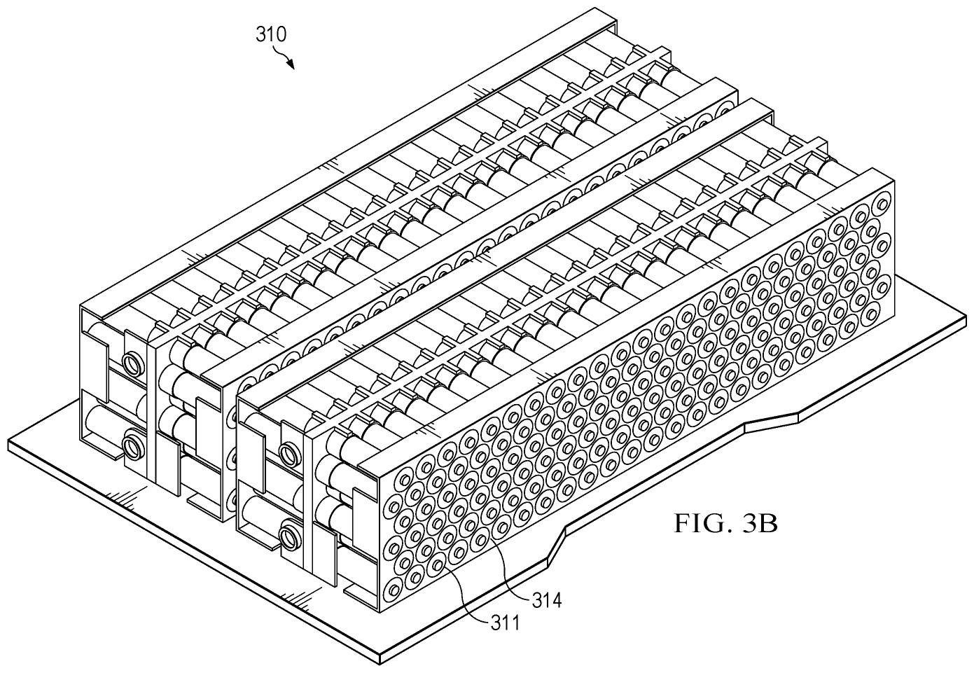

FIGS. 3A and 3B illustrate exemplary batteries where embodiments of the present disclosure may be applied. The embodiments of the batteries illustrated in FIGS. 3A and 3B are for illustration and explanation only. FIGS. 3A and 3B do not limit the scope of this disclosure to any particular implementation of a battery.

In the example of FIG. 3A, the battery 300 is made from an arrangement of energy storage elements (“cells”) 301 inside of an enclosure 302, shown partially cutaway, and is secured within the battery enclosure 202 together with other battery modules. Energy storage elements 301 (cylindrical in the example shown) are held inside the enclosure 302, with spaces 304 in between individual energy storage elements. Likewise, in FIG. 3B, the battery 310 includes energy storage elements 311 with spaces 314 in between individual energy storage elements. At least the spaces 304, 314 are filled with silicone in the process of the present disclosure. Silicone may also fill space between the energy storage elements and the enclosure 302.

Although FIGS. 3A and 3B illustrate examples of a battery, those skilled in the art will recognize that the full structure of a battery module is not depicted in the drawings or described here. Instead, for simplicity and clarity, only so much of the structure of a battery as is necessary for an understanding this disclosure is depicted and described. Various changes may be made to the example of FIGS. 3A and 3B, and improved battery manufacturing to mitigate thermal runaway as described in this disclosure may be used with any other suitable battery.

One simple approach to using silicone polymer for protection against thermal runaways is to use gravity-fed silicone, with natural curing (with no controls). However, that process has a significant risk of non-uniform fill. For battery pack designs that are not sealed, incomplete coverage leaves energy storage elements potentially susceptible to weather elements and thermal influences.

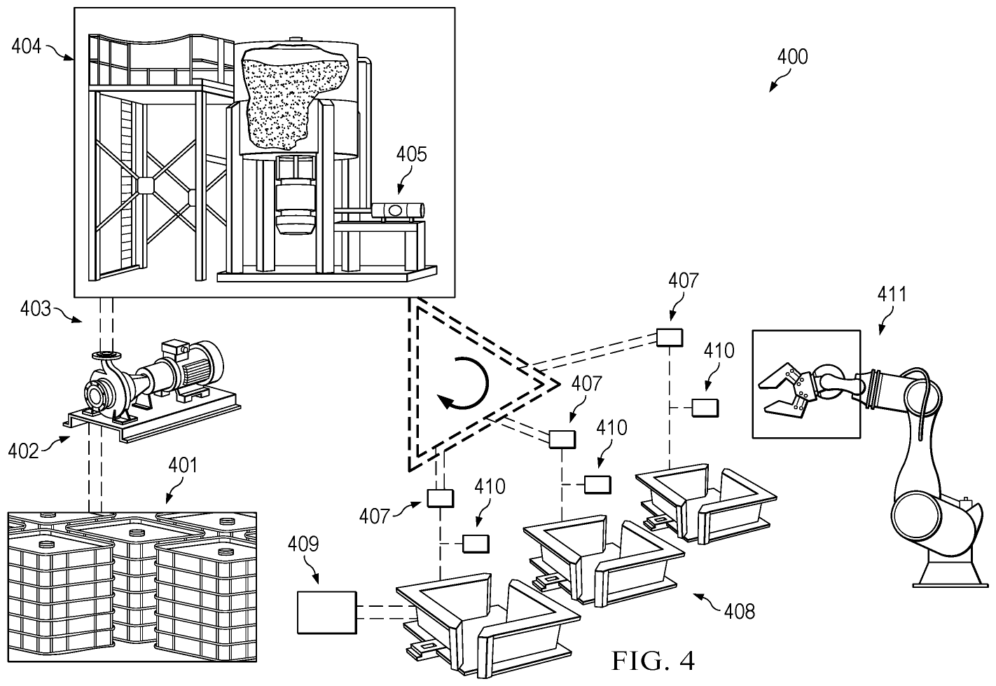

FIG. 4 illustrates an example battery manufacturing method according to embodiments of the present disclosure. The embodiment of the technique illustrated in FIG. 4 is for illustration and explanation only. FIG. 4 does not limit the scope of this disclosure to any particular manufacturing parameters.

FIG. 4 diagrammatically illustrates schematic of an example manufacturing process 400 for silicone polymer (e.g., foam or elastomer) injection according to this disclosure. Examples of silicone polymers suitable for use in the present disclosure include: ESA 720X or RTF 3250 available from Elkem; Sylgard silicone elastomer 184 or 194 available from Dow Corning: Mold Max 10, 20, 25, 30, or 40 available from Reynolds Advanced Materials: Cast-a-Mold Platinum Activator available from Specialty Resin & Chemical; and 15A Silicone Mold Making Kit available from Let's Resin. Steps 401, 402, and 403 represent plant handling of constituents (e.g., silicone base and curing agent) before mixing. The constituents can be solids, liquids or gases. Step 404 represents pre-preparation of the constituents that would not substantially begin the curing reaction. This can be mixing of additives to the constituents to influence the viscosity, density, etc. of the constituents or the final mix. Step 405 represents a pump arrangement to control the ratio of the final mix. Step 406 represents a system to feed the prepared constituents to the mixer. The feed system may or may not be recirculating in nature. Step 407 represents using a mixer as the mechanism to mix the constituents together in a manner triggering the curing reaction. Step 408 represents a mold to contain the battery and the mix from injection to ejection steps. Step 409 represents a hot fluid circulation through the mold, to impart thermal energy to accelerate the reaction when needed. Step 410 represents injection of additives to the mix to influence the rate of reaction when needed. Step 411 represents a device to place batteries in the mold or take them out.

The example in the illustration of FIG. 4 assumes the following:
a two constituent based reaction mix (although the method of the present disclosure is applicable for any number constituents);
three molds in system (although the method is applicable to any number of molds);
recirculation of constituents prior to mixing and no recirculation of mix during or after the mixer (although the method is applicable with or without recirculation);
injection of additives after mixing (although the method is applicable with or without such injection at any stage of the process as long as the quantity of the additive is controlled depending on process variables);
application of heat inside of the mold after/during injection (although the method is applicable by controlling the temperature of the mix or individual constituents through heating or cooling at any stage of the process); and
control over the ratio of the constituents by controlling the pressure of the circulation pumps and the opening time of mixing valves (although the method is applicable to all other mechanisms which would alter the ratio of constituents of the mix on command).

The cure rate of the silicone is dependent on the ratio of the constituents within the mixture. Accordingly, m step 405, the pump arrangement includes electronically controlled valves to control the ratio of the two constituents within the final mix fed into the mixer(s) (step 407) As shown in FIG. 4, individual mixers may be used for each of the molds 408, although the method is also applicable for one mixer feeding more than one mold. The constituent ratio fed by the pump arrangement into a given mixer may be varied during fill of the corresponding mold, so that (for example) the cure rate of mixture injected into the mold at the beginning of a fill process may be slower than the cure rate of mixture injected into that mold at a time after the fill process has begun. In addition, the mixers may be operated independently, and the associated fill process may proceed independently, rather than in coordinated fashion.

Injection of additives in step 410 to the mold fill mixture, to influence the rate of cure reaction, may also be varied in a controlled manner depending on the degree with which the fill process is complete. The variance may extend to the quantity of additive (e.g., with more added early in a fill process than toward the end of a mold fill), as well as the presence or absence of additives within the mixture at all. The nature of the additive being introduced (i.e., curing inhibitor versus curing accelerator) may also be varied between the start and end of a mold fill process.

Since temperature also affects cure rate, beat may be controlled during the process using (for example) hot fluid circulation within the walls of the mold or through the regular heat exchange mechanism of the battery. For example, the temperature or quantity of the mixture injected into the mold may be relatively low, to keep curing slow until the mixture completely fills the mold. Once the mold is filled, the temperature or quantity of the fluid passing through the mold walls may be increased, to impart higher thermal energy accelerating the curing reaction. For a silicone mixture that may have negative temperature coefficient to the rate of curing, this heat application may be reversed, with higher temperatures targeted during the injection step and a lower temperature targeted to accelerate the curing rate. Other physical conditions of the mold (e.g., pressure) may also be varied across the injection and curing steps.

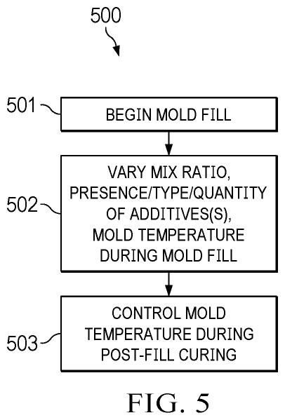

FIG. 5 is a high level flowchart for a process of silicone application to inter-energy storage element gaps during battery manufacturing according to embodiments of the present disclosure. The process of FIG. 5 is for illustration and explanation only. FIG. 5 does not limit the scope of this disclosure to any particular process.

The process 500 begins with filling a mold holding energy storage elements with spaces therebetween with a silicone mixture (step 501) During the time required to fill the mold, the mix ratio, the presence of additive(s), the type(s) of additive(s), and the quant(y)(ies) of additive(s) introduced into the mixture being injected into the mold may be varied, along with the mold temperature (step 502). The mold temperature is then controlled (i.e., either kept relatively constant, or varied in a controlled manner) during post-fill curing (step 503).

Using the process described, curing time is projected to be reduced by a factor of 5 or more, as compared to natural curing. Such a reduction in curing time significantly impacts the number and rate of mold injection systems required, which in turn reduces the capital investment and factory floor space requirements. The expensive molds required may be reused at a higher frequency, and use of factory space and robotic equipment is more efficient. Without a process of the type described herein, the physical space requirement on the factory floor and the complexity of robotic handling equipment needed to keep up with the flow of production of other electric vehicle components could be prohibitive factor, in addition to the capital needs.

Additionally, the approach described above improves the quality of final product by controlling the viscosity of the mix, which determines the flow of the mix inside the complex spaces between energy storage elements of the battery.

It may be advantageous to set forth definitions of certain words and phrases used throughout this patent document. The terms “include” and “comprise.” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C. A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine.” “system.” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
providing a mold holding a plurality of energy storage elements with spaces in between adjacent ones of the energy storage elements;
beginning injection of uncured silicone mixture into the mold to fill the spaces;
during fill of the mold with the injected silicone mixture, varying one or more of:
a ratio of constituents of the silicone mixture being injected,
at least one of a presence or absence of additive(s) in the injected silicone mixture, type(s) of the additive(s) in the injected silicone mixture, or concentrations of the additive(s) in the injected silicone mixture, or
temperature of one of the mold as a whole or specific portions of the mold; and
upon completion of the fill of the mold with the injected silicone mixture, controlling the one of the temperature of the mold as a whole or the specific portions of the mold until curing of the injected silicone mixture is complete.

2. The method according to claim 1, wherein curing of the injected silicone mixture comprises:
controlling other physical condition of the mold in addition to temperature.

3. The method according to claim 1, further comprising:
after completing curing of the injected silicone mixture, removing the plurality of energy storage elements and cured silicone from the mold.

4. The method according to claim 1, wherein the plurality of energy storage elements corresponds to a battery for an electric vehicle.

5. The method according to claim 4, wherein the battery is configured to be held within a skateboard platform.

6. The method according to claim 1, further comprising:
varying the ratio of the constituents in the silicone mixture between a first ratio at a start of the fill of the mold and a second ratio at a time after the start of the fill of the mold.

7. The method according to claim 6, wherein the second ratio of the constituents has a faster cure rate than the first ratio of the constituents.

8. The method according to claim 6, wherein the silicone mixture with the second ratio of constituents has a second viscosity different than a first viscosity of the silicone mixture with the first ratio of the constituents.

9. The method according to claim 1, wherein the silicone mixture cured under a first temperature has a first viscosity different than a second viscosity of the silicone mixture cured under a second temperature.

10. The method according to claim 1, wherein the silicone mixture with a first amount of a first additive has a first viscosity different than a second viscosity of the silicone mixture with a second amount of the first additive.

11. The method according to claim 1, further comprising:
including one of no additive or one additive in the silicone mixture at a start of the fill of the mold and including another additive in the silicone mixture at a time after the start of the fill of the mold.

12. The method according to claim 1, further comprising:
including a first amount of an additive in the silicone mixture at a start of the fill of the mold and a second amount of the additive in the silicone mixture at a time after the start of the fill of the mold.

13. The method according to claim 1, further comprising:
including a first type of additive in the silicone mixture at a start of the fill of the mold and a second type of additive in the silicone mixture at a time after the start of the fill of the mold.

14. The method according to claim 11, wherein the first type of additive causes the silicone mixture to cure at a different rate than the second type of additive.

15. The method according to claim 13, wherein the first type of additive is a curing inhibitor and the second type of additive is a curing accelerator.

16. The method according to claim 1, wherein the injection of the uncured silicone mixture into the mold proceeds via a path which feeds the silicone mixture from a direction counter to a direction that a matter denser than air would take under influence of gravity.
